(19) United States
(12) Patent Application Publication
(10) Pub. No.: US 2017/0191819 A1
(43) Pub. Date: Jul. 6, 2017

(54) ELECTRO-MECHANICAL SENSOR

(71) Applicant: STRETCHSENSE LIMITED, Auckland (NZ)

(72) Inventors: Benjamin Marc O'Brien, Auckland (NZ); Todd Alan Gisby, Auckland (NZ); Antoni Edward Harbuz, Auckland (NZ); Samuel Schlatter, Neuchatel (CH); Ian Scott-Woods, Auckland (NZ)

(73) Assignee: STRETCHSENSE LIMITED, Auckland (NZ)

(21) Appl. No.: 15/508,896

(22) PCT Filed: Sep. 4, 2015
(86) PCT No.: PCT/NZ2015/050130

§ 371 Date: Mar. 3, 2017

(30) Foreign Application Priority Data
Sep. 4, 2014 (NZ) 630075

(51) Int. Cl. G01B 7/16

(52) U.S. Cl. CPC G01B 7/22

(57) ABSTRACT

In one aspect the invention provides an electrical sensor having an electrical capacitance which varies with mechanical deformation to allow instrumenting of deformation by a connected electric circuit, the sensor comprising conductive material separated by dielectric material and operable to deform and change in capacitance with deformation of the capacitor, the capacitor arranged to have a structure of a twisted plane wherein the capacitor is supported in that arrangement by support material.

### FIELD OF THE INVENTION

This invention relates to improvements in respect of Electro-Mechanical Sensors, such as sensors which have electrical characteristics which change with mechanical deformation.

### BACKGROUND OF THE INVENTION

Flexible and compliant circuits are ideal building blocks for integration into soft structures to instrument such structures. They can provide advanced functionality, whether that be in the form of control, logic, or electromechanical transducer elements, for example, without substantially affecting the mechanical behaviour of the structure.

In particular, flexible and compliant circuits such as a dielectric elastomer or other flexible and compliant sensing devices are excellent sensors for soft structures such as the human body, for example. As is typical of soft structures, the human body is capable of large, complex movements in 3D space. It is challenging to attach traditional sensing elements to such a structure where the sensing device has rigid elements, for example. These elements can interfere with behaviour of the soft structure and create soft-to-hard interfaces that are prone to mechanical failure. Intermediate transmission mechanisms are required to convert the large movement of the body to a constrained range and/or type of motion that is appropriate for the sensor, and these add complexity and ultimately potentially sources of error.

Flexible and compliant circuits eliminate the need for complicated intermediate transmission mechanisms. They are capable of conforming to the body, and by virtue of being made of soft materials, can deform into complicated shapes to ensure they stay conformed to the body for a large range of motion. For example, a flexible and compliant second skin could be instrumented with flexible and compliant sensors so that as the body moves, the second skin stretches in synchrony with the actual skin, transmitting stretch information to the stretch sensitive flexible and compliant circuits so that it can be digitized and used as an input for a larger system.

Flexible and compliant capacitive sensors are especially well suited to measuring soft structures. They are sensitive to changes in geometry, but exhibit minimal sensitivity to humidity and temperature, and can easily be electrically shielded to block external sources of electrical noise.

A challenge arises in the use of flexible and compliant capacitive sensors in that they are sensitive to deformations in all directions. The overall capacitance output is the aggregate of deformations in all directions and, without additional information there are multiple modes of deformation that could result in the same aggregate capacitance. This implies limitations on information on the state of a given sensor.

It would therefore be of advantage to have a sensor which overcomes challenges which arise in the use of flexible and compliant capacitive sensors.

It would therefore be of advantage to have a sensor which could address any or all of the above problems, or at least provide the public with an alternative choice.

It would therefore be of advantage to have a method of manufacturing a sensor which overcomes challenges which arise in the use of flexible and compliant capacitive sensors.

It would therefore be of advantage to have a method of manufacturing a sensor which could address any or all of the above problems, or at least provide the public with an alternative choice.

### DISCLOSURE OF THE INVENTION

According to an aspect of the present invention there is provided an electrical sensor having an electrical capacitance which varies with mechanical deformation to allow instrumenting of deformation by a connected electric circuit, the sensor comprising:

conductive material separated by dielectric material and operable to deform and change in capacitance with deformation of the capacitor;

the capacitor arranged to have a structure of a twisted plane wherein the capacitor is supported in that arrangement by support material.

The support material may be elastic.

The conductive material may be elastic.

The dielectric material separating the conductive material may be elastic.

The capacitor may be elastic.

The support material may be no more elastic approximately than the conductive material of the capacitor.

The support material may be no more elastic approximately than the conductive material of the capacitor.

The support material may be no more elastic than the capacitor.

The support material may be less elastic that the capacitor.

The capacitor maybe arranged to have a periodic twist structure.

The sensor may comprise bend-adjustment feature be arranged to cause a surface, defining a juncture between regions of relative extension and contraction within the support material under bending deformation of the sensor, to extend along the centre of the twisted structure of the capacitor.

This causes a central path of the twisted structure of the capacitor to experience an extension which is a mean of the extension and contraction in a region containing the twisted structure of the capacitor.

This causes an extension in a region of the capacitor to be paired with contraction in another region of the capacitor.

This causes extension of the bend-feature may be bend-adjustment material having elasticity which is different to the elasticity of support material about the capacitor.

The bend-adjustment material may have elasticity which is less elastic than support material in a region about the capacitor.

The bend-adjustment material may comprise a strip of material extending along a side of the sensor. The strip may extend along a side of the sensor intended as the inside radius of the sensor as it is bent in use.

A bend-adjustment feature may comprise slits formed in a side of the sensor.

The capacitor may be a dielectric elastomer device.

According to another aspect of the present invention comprises a method of manufacture of a sensor, the method comprising the steps of:

forming a capacitor ribbon comprising two or more electrodes formed of conductive material separated by dielectric material;

rotating an end of the capacitor ribbon relative to another end of the capacitor ribbon to arrange the capacitor in a shape with sections rotated relative to each; and

providing support material about the capacitor to support the capacitor in said shape.

The conductive material of the electrodes and the dielectric material may be flexible and compliant.

The conductive material of the electrodes and the dielectric material may be elastic.

The support material may be flexible and compliant.

The support material may be elastic.

The method may comprise the step of providing a strip of material to a side of the sensor, the material resisting extension of proximate support material.

Embodiments of the present invention provide a capacitor with sections of capacitor electrodes separated by dielectric material at a variety of orientations at a variety of embedded in the sensing element.

Embodiments of the present invention provide a capacitor with sections of capacitor electrodes separated by dielectric material at a variety of orientations at a variety of embedded in a given region and/or volume and/or section of a sensing element.

As used herein term ‘twisted’ and similar broadly refers to a shape such as would be arranged by turning the ends of a sheet in opposite directions about the ends of a path between the ends, so that parts previously in the same straight line and plane are located in a spiral curve.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 is a schematic diagram showing the effects on capacitance of deformations of a capacitor in each axis;

FIG. 2 is a schematic top-down diagram of a sensor illustrating two different deformations that have the equivalent effect on the capacitance of the sensor. A doubling in length of one axis of a capacitive sensor has the same effect as a doubling in length of the perpendicular axis;

FIG. 3 is a schematic diagram showing how reorienting the capacitor with respect to the structure in which it is embedded changes the response of the capacitance sensor to deformations along perpendicular axes;

FIG. 4 is a schematic diagram showing how using both absolute and relative measurements from two sensors embedded in a soft structure at different orientations can be used to determine the magnitude of deformations in multiple axes;

FIG. 5 is a schematic diagram showing how additional sensors can provide redundancy whilst also potentially providing compensation for effects due to temperature or humidity, for example;

FIG. 6 is a schematic diagram showing how the orientation of a capacitive sensor embedded within a soft structure relative to the deformation of the soft structure affects the sensitivity of the sensor;

FIG. 7: is a schematic diagram showing how by combining and/or comparing the output of multiple sensing elements embedded at different orientations within a soft structure can be used to cancel or isolate deformations along an axis of interest;

FIG. 8: is a schematic diagram showing the cross section of a tubular capacitive sensor embedded in soft structure. If the mechanical properties of the sensor do not match the surrounding material however deformation of the structure creates complex stress states in the sensing element;

FIG. 9 is a schematic diagram of a uniaxial stretch sensor according to a preferred embodiment of the present invention which is depicted as formed by taking a narrow planar sensor, applying a rotation down the length of a sensor and embedding the sensor in a soft matrix to lock the rotation in;

FIG. 10 is a schematic diagram of the same embodiment of the present invention as FIG. 9 and illustrates how rotation down the length of a sensor can be used to cancel out deformations that occur along the radial axis, this is to cancel out the effects on the overall capacitance for deformations that occur perpendicular to the axis aligned with the length of the sensor;

FIG. 11 is a schematic diagram of a stretch sensor according to the same the same embodiment as FIGS. 9 and 10 and illustrates the effect of a deformation adjustment strip;

FIG. 12 is a schematic diagram of a stretch sensor according to the same the same embodiment as FIGS. 9 and 11 and illustrates the effect of a common deformation on orthogonally orientated cross-sections of the same capacitor;

FIG. 13 is a schematic diagram showing the main steps of manufacturing a uniaxial stretch sensor of the same embodiment as FIGS. 9 to 12 by taking a narrow planar sensor, applying a rotation down the length of a sensor and embedding the sensor in a soft matrix to lock the rotation in;

FIG. 14 shows is a schematic diagram of a stretch sensor according to the same the same embodiment as FIGS. 9 and 13 and illustrates the interaction of a transverse deformation an the twisted shape of the capacitor;

FIG. 15 is a schematic diagram of a stretch sensor according to the same the same embodiment as FIGS. 9 and 14 illustrating different modes of deformation;

Further aspects of the invention will become apparent from the following description of the invention which is given by way of example only of particular embodiments.

### BEST MODES FOR CARRYING OUT THE INVENTION

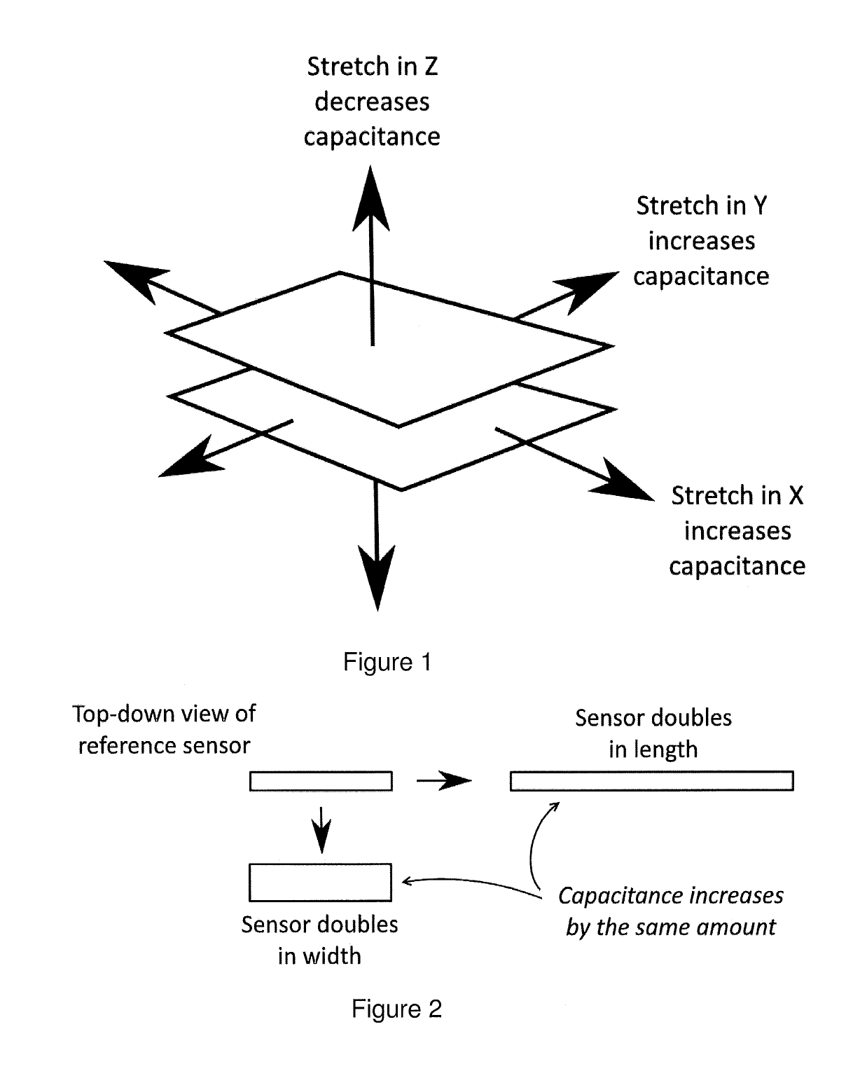

A challenge with a flexible and compliant capacitor is that it is sensitive to deformations in any direction as depicted in FIG. 1. For example, for a planar flexible and compliant capacitor stretch along the X axis is indistinguishable from stretch along the Y axis. It is possible to generate the same capacitance output with significantly different combinations of stretch along each of the primary axes.

Doubling the length of the flexible and compliant capacitor in the X direction while keeping the length in the Y direction constant results in the same change in capacitance as if the capacitor had been doubled in length in the Y direction while keeping the length in X direction constant. This is depicted in FIG. 2. Rotating the capacitor in plane cannot change this effect.

Thus without additional information, only the aggregate effect of any deformations that the capacitor undergoes can be measured, and it is not possible to break down this aggregate output into its individual X, Y, or Z components.

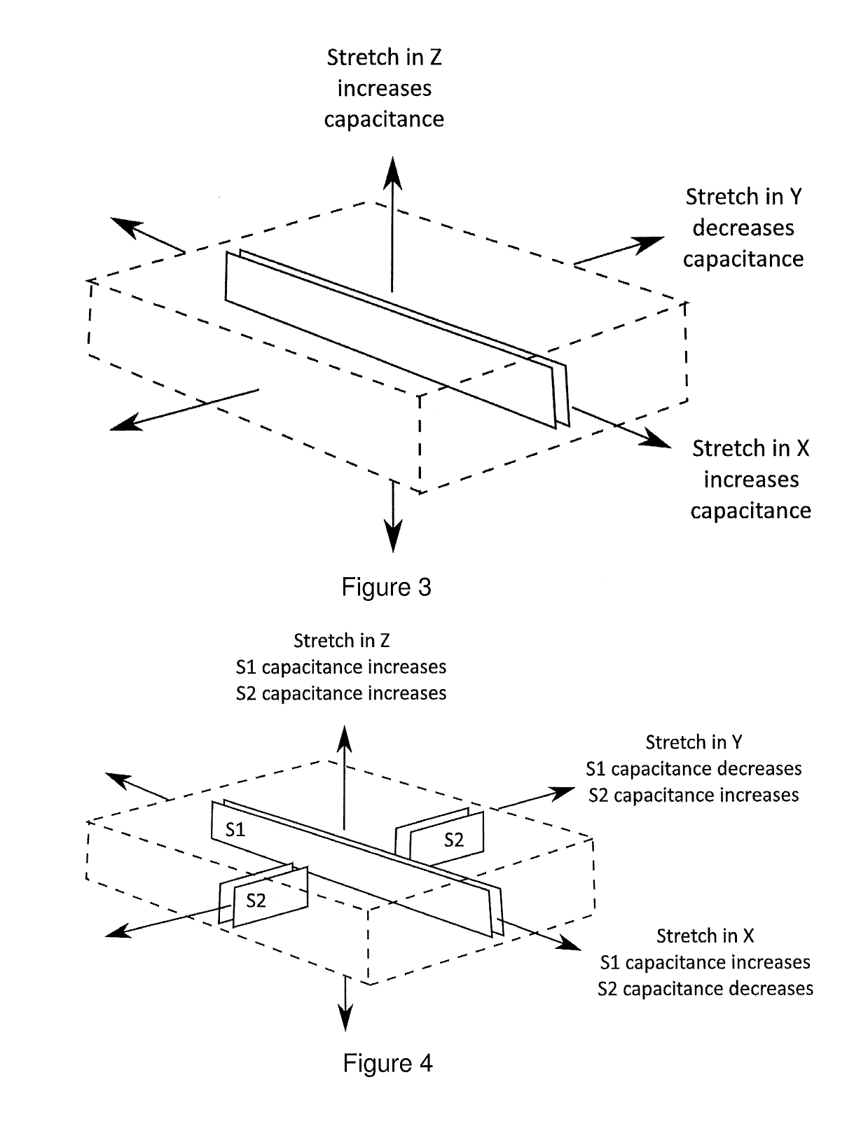

However, rotating the flexible and compliant capacitor within the sensor to be out of plane provides one way of changing the sensitivity of the sensor to in-plane deformations. FIG. 3 depicts a capacitor is embedded vertically in a sensor. Now when the sensor is stretched in the Y direction, the capacitance will decrease as the separation between the electrodes increases. In comparison, when the sensor is stretched in the X or Z direction, the capacitance will increase. However, while the response of the sensor to deformations along each of the primary axes has been modified due to reorienting the capacitor out of plane, it is still not possible to break down the sensor output into X, Y, and Z components.

To separate the deformation of the sensor into X, Y, and Z components, at least two flexible and compliant capacitors must be embedded in the sensor in different, ideally orthogonal, orientations.

FIG. 4 depicts capacitor S1 and capacitor S2 oriented perpendicular to each other, thus providing different sensitivities to deformations along each axis. By looking at the individual capacitances of S1 and S2 as well as comparing the differences between S1 and S2, the magnitudes of deformation along each axis can be derived. For example, when stretched in the X direction, S1 increases while S2 decreases; when stretched in the Y direction, S1 decreases while S2 increases; and when stretched in the Z direction, both S1 and S2 increase. This enables X, Y, and Z components of the deformations can be distinguished.

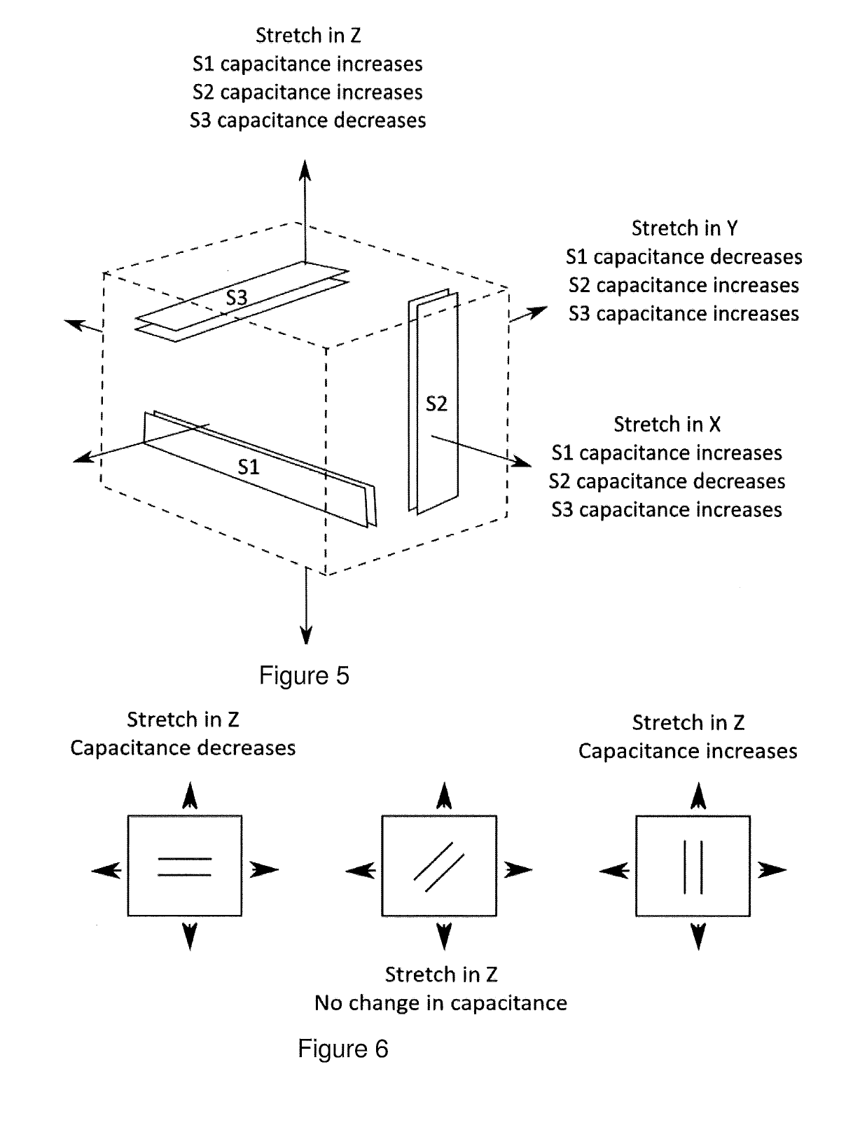

Increasing the number of flexible and compliant capacitors to three, each of which are oriented perpendicular to each other (FIG. 5), provides redundancy in terms of stretch information. Again by analysing S1, S2, and S3 both individually and relative to each other the complete stress state of the sensor can be determined. Furthermore, having his additional information allows for additional external stimuli to be compensated for. For instance, temperature and/or humidity may modify the dielectric constant and therefore the capacitance of the flexible and compliant capacitor without changing its physical dimensions. However, assuming this affects S1, S2, and S3 equally the effects of these changes become analogous to a “common mode” component to the capacitance data coming from each capacitor, and can thus be calibrated out.

A challenge with embedding multiple flexible and compliant capacitors into a sensor however is that they require a larger number of electrical interconnects, the capacitors and the sensor have a complicated 3D geometry and are made up of several parts, and advanced mathematics are required to account for the different effects. Furthermore it is a significant challenge to match the mechanical behaviour of the flexible and compliant capacitor to the mechanical behaviour of the surrounding matrix in which it is embedded, and any mismatch is likely to result in complex and/or non-homogenous stress states developing between capacitor and support material that will influence the output of the sensor.

To simplify this problem first let us return to the effects of capacitor orientation relative to a given deformation that is applied to the sensor. With reference to FIG. 6, if the sensor is stretched in the Z direction and the capacitor is oriented perpendicular to the Z axis, capacitance will decrease. If the sensor is stretched in the Z direction and the capacitor is oriented at 45 degrees to the Z axis, the increase in the separation of the capacitors electrodes combined with the increase in area of the capacitors electrodes have equal and opposite effects, resulting in no net change in capacitance. Finally, if the sensor is stretched in the Z direction and the capacitor is oriented to be parallel with the Z axis, the capacitance will increase.

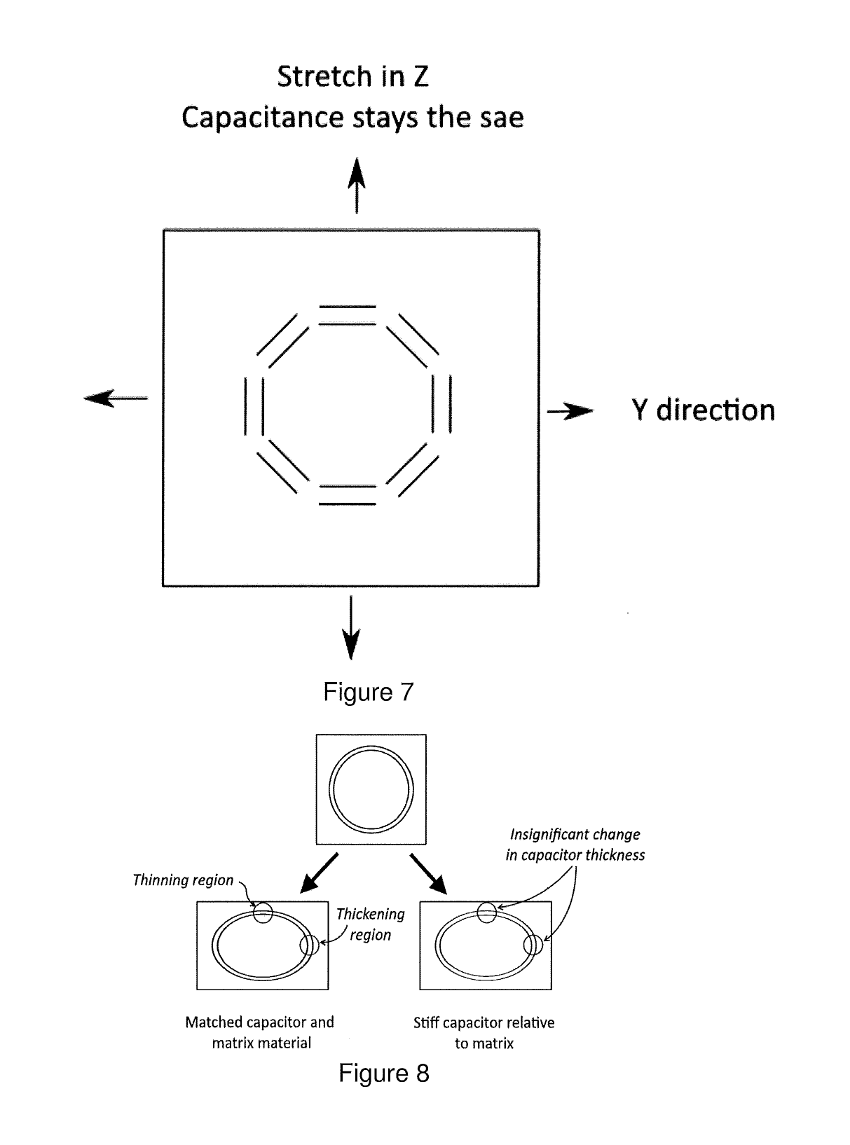

Embedding multiple flexible and compliant capacitors into a single sensor at different orientations enables the sensitivity of the sensor to deformations in particular directions to be tuned. For example, FIG. 7 shows eight sensing elements have arranged into an octagonal configuration. Where the center-top capacitance is defined as S1 and the remaining sensors are defined sequentially from S2 to S8 in a clockwise direction, stretch in the Z direction results in no net change in the sum of the eight capacitances, S1 to S8. Thus the sensor is insensitive to deformation in the Z direction. This is because the sum of the S1 and S5 capacitances decreases as a result of a deformation in the Z direction by the same amount that the sum of the S3 and S7 increases, while S2, S4, S6, and S8 have no change in capacitance due to their 45 degree orientation to the Z direction. Thus the net change in capacitance is zero. The same can be said for deformations in the Y direction, and for planar deformations that have both Y and Z components. In contrast, any deformation in the X direction (not shown) affects all of the capacitances equally, thus the sum of the changes in capacitance will be non-zero.

The aforementioned result implies a tubular flexible and compliant capacitor is an ideal form factor for a sensor that is sensitive to changes in the length of the tube, but insensitive to deformations perpendicular to the central axis of the tube that result in the cross section of the tube becoming ellipsoid.

However, there are practical challenges associated with this form factor. It is difficult to produce a tubular flexible and compliant capacitor, and if there is any mismatch between the mechanical behaviour of the capacitor and the surrounding support matrix in which the capacitor is embedded, any deformation perpendicular to the centre axis of the tube will cause the sensor to adopt a complex mechanical stress state. For example, FIG. 8 illustrates that if the mechanical properties of the capacitor matches the support matrix, the sensor behaves as a homogenous solid and uniformly distributed changes in capacitor thickness create a zero sum change in capacitance. However, if the capacitor is stiffer than the surrounding support matrix, for example, bending occurs in the walls of the tubular capacitor but changes in capacitor thickness are suppressed, and stress concentrations occur at the interface between the capacitor and the support matrix. Thus the deformation of the overall sensor, i.e., the sensor and the matrix, is not homogenous and changes in capacitance may not cancel out.

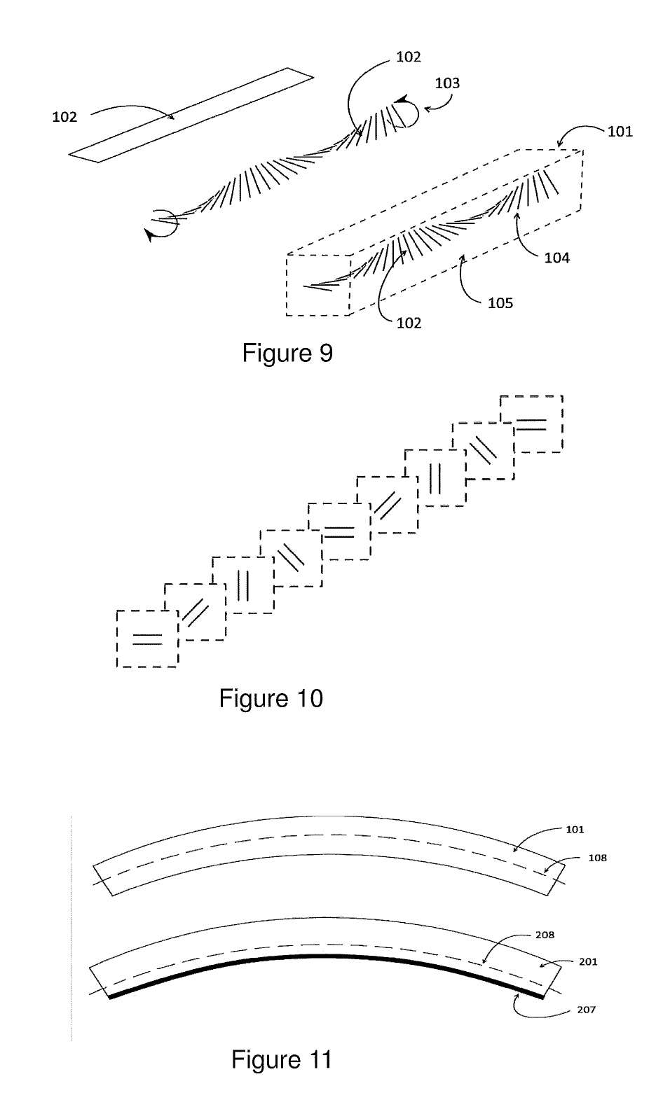

FIG. 9 schematically depicts a sensor 101 according to a preferred embodiment of the present invention. The sensor 101 is flexible and compliant and has a capacitance characteristics that change with deformation to allow a connected electrical device (not shown) to measure deformation characteristics by measuring changes in capacitance characteristics. In this specific embodiment the sensor is formed of flexible and compliant materials that are elastic and which do not compress under deformation. The materials are selected to be resilient over repeated deformations.

The sensor has a capacitor 102 which has the structure of a twisted-sheet capacitor. The arrow 103 depicts a rotation of one end of the capacitor with respect to the other. In this example the sensor 101 and capacitor are elongate and the twisted structure of the capacitor resembles a twisted-ribbon.

The capacitor 102 of this example is formed of two layers of conductive elastic material separated by a layer of dielectric elastic material. The conductive layers provide electrodes of a capacitor and the dielectric layer provides a dielectric for the capacitor. The capacitance of the capacitor is variable with extension of the capacitor. The variation may be measured or calculated by an electrical device (not shown) connected to the capacitor 102.

The twisted structure of the capacitor 102 is depicted by lines 104 transverse to the length of the elongate capacitor of this example. The structure of the capacitor 102 may also be described as rotated along central trajectory, as depicted by relative rotation of the lines 104 along the capacitor.

The capacitor 102 is supported in the twisted or rotated structure by support material 105. In this example the support material is an elastic material. The support material acts to both support the capacitor in it's twisted or rotated structure and to cause the capacitor to deform as the support material deforms. The support material can be affixed to an object to be instrumented and the support material will deform and the object moves or deforms, such as by bending. By action of the support material, this deformation of the sensor will cause deformation of the capacitor supported in a twisted or rotated structure. In the preferred embodiment the support material has the same or less elasticity as the materials of the capacitor.

FIG. 10 depicts the orientation of sections of the capacitor 102 along the length of the sensor 101. Each section 102a to 102i represents a cross-section of the capacitor, each having two electrodes 106a and 106b. In this embodiment the angular orientation of the capacitor cross-sections 102a to 102i of the sensor 101 is different. Specific to this particular embodiment the orientations of capacitor cross-sections is rotated monotonically with respect to the next.

The sensor 101 of this embodiment is sensitive to changes in length of the sensor, but insensitive to changes in the dimensions transverse to the length of the sensor. As depicted in FIG. 10, a section of the sensor will contain various cross-sections 102n of the capacitor. A change in the length of the sensor 101 will cause changes in the dimensions of the capacitances of each capacitor cross-section 102n, irrespective of orientation will cause the electrodes of the capacitor to draw together. Changes transverse to the length of the sensor will cause a drawing together of electrodes 106 in a given cross-section and a drawing apart of electrodes of a cross-section orthogonal to that given cross-section.

FIG. 11 shows the sensor 101 of FIG. 9 with a sensor 201 according to an alternative embodiment of the present invention. The sensor 201 has a layer or strip 211 of material which is less elastic that the support material.

The strip 211 acts as a deformation adjustment feature. In these examples the strip 211 restricts extension of the sensor 201 in the region of the strip relative to other parts of the sensor, such as the opposite side 106 of the sensor 101. The effect of this is to control the depth 212 of the juncture of regions of relative extension 213 and 214 and contraction. In this embodiment the juncture is arranged to extend along a path 108 or 208 which represents a mode of deformation which the sensor is intended to measure.

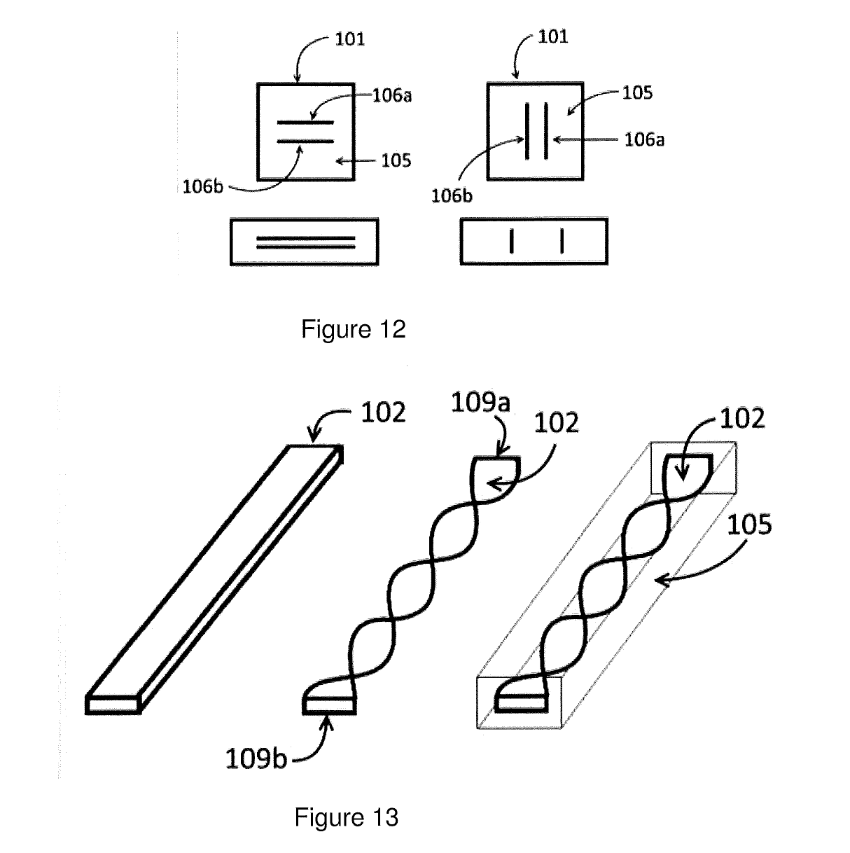

FIG. 12 depicts the effect of pairs of orthogonal cross-sections of the capacitor 102 under the same deformations, such as would occur if they were proximate along the length of the sensor. The upper pair of sensors cross-sections 102a and 102c are deformed into a relatively vertically elongate shape such as might occur if the sensor 101 is bent to the right or left with respect to the page or compressed from the right and left of the page. The electrode pairs 106 of the capacitor of cross-section 102a are drawn apart decreasing the capacitance of that section but the capacitor cross-section of the sensor cross-section 102c are drawn together to increase capacitance to balance the change in capacitance of the cross-section 102a to a net change due to overall extension of the sensor.

In use the sensor 201 is mechanically coupled to an object to instrument deformation of the object. In a typical example the sensor will be placed against a body part to bend with the body part. As the support material bends, layers in the support material will extend or contract to varying degrees relatively to each other. If the strip has suitable elasticity or lack of elasticity compared to the support material and the depth 207 of the support material and/or width 108 of the capacitor is suitable then a central surface 109 within the support material will see only extension and regions above and below the surface will experience either extension or contraction. If the central line 110 of the capacitor extends along the surface the centre of the capacitor 110 and any sections where lines 103 lie in the surface 109 is will experience only extension. Regions either side of the central bend surface will either extend or contract. Sections of the elongate capacitor, which have lines 103 extending through the central bend surface will experience both extension and contraction, but would average to the extension seen along the surface of the bend. The capacitance in these sections would therefore change the same as the extend-only sections of the capacitor. This allows the degree of bending or simply the extension in the sensor due to bending to be instrumented.

FIG. 13 schematically depicts a method of manufacture of a sensor 101 according to a preferred embodiment of the present invention.

In a first step an elastic capacitor 102 is formed with two layers of elastic conductive material separated by a layer of elastic dielectric material. In alternative embodiments the capacitor may have three or more conductive layers separated by two or more layers of dielectric material. In this example the capacitor is elongate.

In a second step the ends 109a and 109b of the elongate capacitor are rotated relative to each other to arrange the capacitor 102 in a rotated or twisted structure.

In a third step the capacitor is set in elastic support material 105 to support the capacitor in the twisted structure.

In a forth step strip of material (not shown) that is less elastic than the support material and/or capacitor material is applied, to adjusts a mathematical surface within the sensor which defines regions of relative extension and contraction of the sensor.

By this method of manufacture the sensor 101 can be formed using simple fabrication methods. For example, a long narrow sensor 101 can be fabricated using planar 2D manufacturing methods, then by simply rotating the ends in opposite directions to impart a twist down the length of the capacitor and embedding it in a soft support matrix, a true uniaxial sensor is created.

In this specific embodiment the capacitor is formed by laminating electrodes of elastic material which is fluid prior to setting, such as silicon, impregnated with conductive material, such as carbon, with dielectric material which is similarly fluid prior to setting.

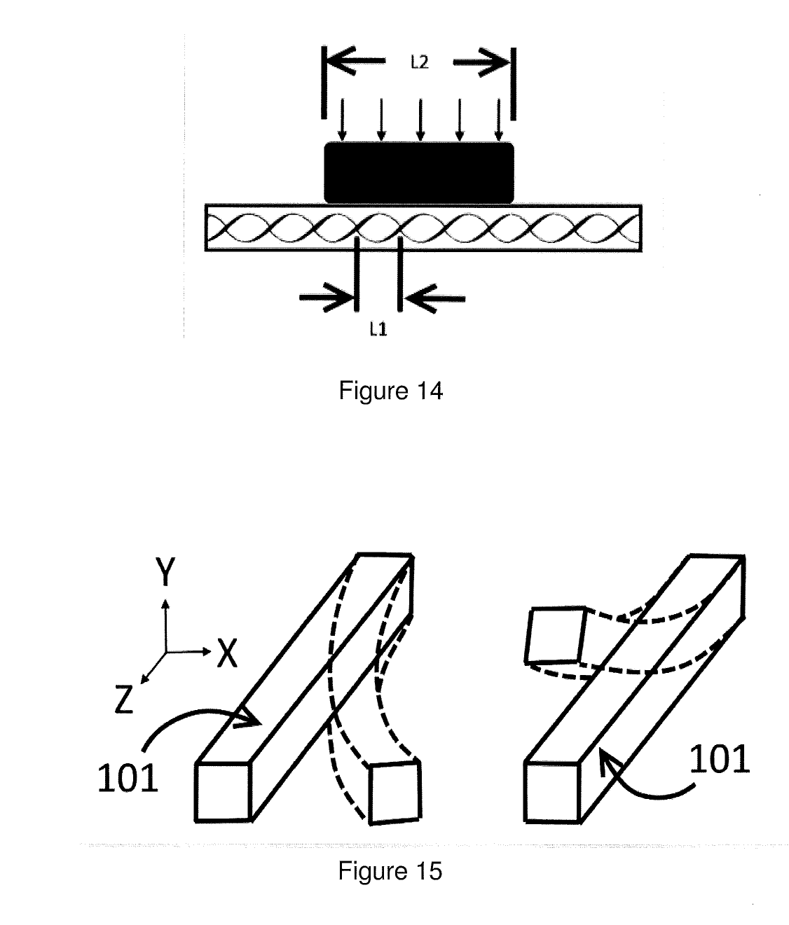

FIG. 14 depicts the relationship of the twisted structure to a deforming pressure applied transverse or perpendicular to the line of a twisted capacitor. Deformations perpendicular to the length direction which are distributed over a section of the twisted structure deform the capacitor at all possible capacitor cross-section orientations, as described with reference to FIG. 6, and the sum of the capacitance changes within this section substantially equal to zero.

FIG. 15 depicts a sensor 101 being bent in two alternate planes with the same extension of the capacitor and which manifest as the same change in capacitance of the capacitor 102. FIG. 15 illustrates different modes of deformation. In each example shown the length of the sensor 101 will be extended if the sensor is affixed to an outside radius of a deforming structure to be instrumented. This may be a mode of deformation that sensor is intended to retain sensitivity and this is achieved by the capacitor 102, though in a twisted-structure, extending along a path which is expected to extend with the sensor. Other modes of deformation, such as whether the sensor is bent left vs right or upwards may be desensitised by the capacitor being arranged to have a twists about a path through the elongate sensor so that the same capacitor has cross-sections which are orthogonal relative to other sections.

Further and additional embodiments of the invention will now be described.

In its simplest form a uniform twist along the length of the sensor according to embodiments of the present invention ensures that, provided a contact area applying pressure to the sensor transverse to the length of the sensor is larger than a period of the twist, any deformation of the sensor is effectively evenly distributed across segments of the sensor at every orientation of the capacitor cross-section relative to the line of action of the pressure. This serves to effectively desensitize the sensor to the pressure, as the segments of the sensor that deform so as to increase in capacitance are substantially equal to the segments of the sensor that deform so as to decrease in capacitance, and thus substantially counteract each other with respect to their effect on the overall capacitance of the twisted sensor structure. The ratio of segments that increase in capacitance relative to those that decrease in capacitance for a given pressure need not be equal however, and it is possible to tune the sensitivity of the structure by varying the proportion of the sensor length that has a particular orientation to a given deformation. For example, this anisotropic sensitivity could be tuned by having flat segments of the sensor within the twisted structure that are oriented at a specific angle relative to an expected pressure. Using this simple method of controlling the proportion of the length of sensor that has a particular orientation can be used to create a sensor structure that has different sensitivity in all three primary orthogonal axes.

The twisted-ribbon structure of sensor 101 is an example of a structure which is achievable by an integrated deformable capacitor which provides multiple orientations of the electrodes of the capacitor in any given region or section of the sensor so that deformations experienced by the region and by the capacitor in the region involve deformations in the electrodes which are balanced by electrodes in the region or section having different orientations. Ideally any given region, to some working resolution has pairs of orthogonally electrodes. However, the reader will appreciate that this may not be required in some applications. In alternative embodiments any structure of capacitor which achieves suitably matched orientations of substantially the same capacitor may be used.

Some embodiments of the sensor may have a region of support material with increases elastic modulus to encourage greater extension to control bending characteristics of the sensor. For example the depth within the sensor which is relatively extending versus relatively contracting may be determined. Some embodiments of the sensor may have slits in the support material to control the bending characteristics of the sensor.

In alternative embodiments cross-sections of the capacitor may be rotated non-monotonically relative to other sections along the length of the sensor. Alternatively expressed the rotation or relative twist is not uniform along the whole length. In some embodiments alternating long twist then tight twist are provided. These embodiments may have varying sensitivity to pressure in different directions.

Embodiments of the present invention overcome challenges observed by the applicant arising from planar flexible and compliant capacitive sensors being sensitive to any change in geometry.

Embodiments provide sensors that may have adjusted or reduced sensitivity to given modes of deformation.

Embodiments provide a change in electrically measurable or characteristics which are the aggregate of deformations in all directions. These embodiments provide information on selected modes of deformation, which might not be possible otherwise without additional information.

Embodiments of the present invention allow instrumenting of deformations in a given mode of deformation, such as along a length or length of a an elongate sensor which is initially straight prior to deformation by desensitising other modes by arranging the capacitor to have electrode and dielectric sections which deform in the desensitised modes so as to tend to cancel respective changes in capacitance due to deformation in those modes but experience common changes in deformation from non-desensitised modes of deformation. This may have advantages in eliminate a need to compare both the absolute and relative values of each capacitance in separate capacitances aligned in to experience deformations along multiple axes. This may eliminate a need for additional interconnects, and additional post processing and co-ordination of the capacitor outputs in order to identify the deformation mode of interest.

Embodiments of the present invention provide a sensor is described which includes a flexible and compliant capacitor configured in a 3 dimensional shape embedded in a flexible and compliant matrix that has the key attribute of being substantially insensitive to deformations arising from changes in geometry that are not aligned to a desired axis of interest. Key aspects of this sensor will become apparent from the following summary.

In some embodiments the sensor is both flexible and compliant.

In some embodiments the sensor has one axis aligned with the desired direction of maximum sensitivity.

In some embodiments the sensor is sensitive to changes in the length of the axis aligned with the desired direction of maximum sensitivity, but substantially insensitive to changes in the length of the axes aligned perpendicular to the axis aligned with the direction of maximum sensitivity.

In some embodiments the sensor includes an electrical circuit that is both flexible and compliant.

In some embodiments the flexible and compliant circuit included in the sensor is a flexible and compliant capacitor.

In some embodiments the flexible and compliant capacitor consists of at least one flexible and compliant non-electrically conductive dielectric that is sandwiched between at least two flexible and compliant electrically conductive layers.

In some embodiments the flexible and compliant capacitor is formed by assembling electrically conducting and non-conducting layers that are manufactured in a substantially planar form.

In some embodiments the flexible and compliant capacitor is formed by selectively depositing electrically conducting and electrically non-conducting materials to form a flexible and compliant capacitor.

In some embodiments the output of the sensor is related to the geometry of the flexible and compliant capacitor.

In some embodiments one axis of the flexible and compliant capacitor is aligned with the axis of the sensor that is aligned with the desired direction of maximum sensitivity.

In some embodiments the length of the flexible and compliant capacitor along the axis aligned with the direction of maximum sensitivity is greater than the length of the flexible and compliant capacitor along each of the axes perpendicular to the axis aligned with the direction of maximum sensitivity.

In some embodiments ends of the flexible and compliant capacitor thorough which the axis of the direction of maximum sensitivity passes through are rotated in opposite directions relative to each other to impart a twist on the capacitor.

In some embodiments ends of the flexible and compliant capacitor undergo a rotation of at least 90 degrees relative to each other when the capacitor is twisted.

In some embodiments the flexible and compliant capacitor remains in a twisted state during its use.

In some embodiments the flexible and compliant capacitor is prevented from untwisting.

In some embodiments the flexible and compliant capacitor is embedded in a flexible and compliant matrix to prevent it from untwisting.

In some embodiments deformation of the sensor arising from pressures applied perpendicular to the axis of maximum sensitivity are distributed over at least one quarter of the period of the twist in the flexible and compliant capacitor by the flexible and compliant matrix.

In some embodiments deformation of the sensor arising from pressures applied perpendicular to the axis of maximum sensitivity are uniformly distributed over at least one quarter of the period of the twist in the flexible and compliant capacitor by the flexible and compliant matrix.

In some embodiments the change in capacitance for a localised region of the sensor that is due to deformation as a result of an external pressure that is not aligned with the axis of maximum sensitivity, where the localised region is defined as being some distance from the end of the flexible and compliant capacitor, is governed by the angle of incidence between the line of action of the external pressure and the surface of the flexible and compliant capacitor at that distance along the flexible and compliant capacitor.

In some embodiments the integral of the changes in capacitance of each localised region of the sensor along the length of the flexible and compliant capacitor over which the deformation generated by the external pressure not aligned with the axis of maximum sensitivity is substantially equal to zero.

In some embodiments the change in capacitance for a localised region of the sensor that is due to deformation as a result of an external pressure that is aligned with the axis of maximum sensitivity, where the localised region is defined as being some distance from the end of the flexible and compliant capacitor, is positive for deformations that result in the sensor becoming longer along the axis of maxim sensitivity and negative for deformations that result in the sensor becoming shorter, irrespective of the angle of rotation of the localised region with respect to the end of the sensor.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A sensor having an electrical capacitance which varies with mechanical deformation to allow instrumenting of deformation by a connected electric circuit, the sensor comprising:
conductive material separated by dielectric material to provide a capacitor, the capacitor operable to deform and change in capacitance with deformation; and
the capacitor arranged to have a structure of a twisted plane,
wherein the capacitor is supported in that arrangement by support material.

2. The sensor of claim 1, wherein one or more of the following are elastic: the support material, the conductive material of the capacitor, and the dielectric material separating the conductive material of the capacitor.

3. The sensor of claim 1, wherein the capacitor is a dielectric elastomer device.

4. The sensor of claim 1, wherein the support material is no more elastic approximately than one or more of the conductive material of the capacitor and the dielectric material separating the conductive material of the capacitor.

5. The sensor of claim 1, wherein the support material is less elastic approximately than one or more of the conductive material of the capacitor and the dielectric material separating the conductive material of the capacitor.

6. The sensor of claim 1, wherein the capacitor is arranged to have a structure of a periodic twisted plane.

7. The sensor of claim 1, comprising a deformation-adjustment feature arranged to cause a surface which defines a juncture between regions of relative extension and contraction within the support material under bending deformation of the sensor to extend along the centre of the twisted structure of the capacitor.

8-15. (canceled)

16. The sensor of claim 7, wherein the deformation adjustment feature comprises a material which is less elastic than support material in a region about the capacitor.

17. The sensor of claim 16, wherein the deformation-adjustment material comprises a strip of material extending along a side of the sensor.

18. A method of manufacture of a sensor, the method comprising the steps of:
forming a deformable capacitor comprising two or more electrodes formed of conductive material separated by dielectric material,
rotating an end of the capacitor relative to another end of the capacitor to arrange the capacitor in a shape extending along a path with sections rotated relative to other sections; and
providing support material about the capacitor to support the capacitor in said shape.

19. The method of manufacture of a sensor of claim 18, wherein one or more of the following are flexible and compliant: the conductive material of the electrodes, the dielectric material separating the electrodes and the support material.

20. The method of manufacture of a sensor of claim 18, wherein the capacitor is a dielectric elastomer device.

21. The method of manufacture of a sensor of claim 18, comprising a step of providing a material for a side of the sensor, the material being less elastic than the support material and operable to resist extension of support material in a region proximate to the strip.
